(19) United States
(12) Patent Application Publication
(10) Pub. No.: US 2011/0072218 A1
(43) Pub. Date: Mar. 24, 2011

(54) PREFETCH PROMOTION MECHANISM TO REDUCE CACHE POLLUTION

(76) Inventors: Srilatha Manne, Portland, OR (US); Steven K. Reinhardt, Vancouver, WA (US); Lisa Hsu, Bellevue, WA (US)

(21) Appl. No.: 12/566,196

(22) Filed: Sep. 24, 2009

(51) Int. Cl. G06F 12/08; G06F 12/00

(52) U.S. Cl. 711/136; 711/137; 711/E12.001; 711/E12.057

(57) ABSTRACT

A processor is disclosed. The processor includes an execution core, a cache memory, and a prefetcher coupled to the cache memory. The prefetcher is configured to fetch a first cache line from a lower level memory and to load the cache line into the cache. The cache is further configured to designate the cache line as a most recently used (MRU) cache line responsive to the execution core asserting N demand requests for the cache line, wherein N is an integer greater than 1. The cache is configured to inhibit the cache line from being promoted to the MRU position if it receives fewer than N demand requests.

### BACKGROUND OF THE INVENTION

1. Field of the Invention

This invention relates to processors, and more particularly, to cache subsystems within processors.

2. Description of the Related Art

Accesses of data from a computer system memory for loading into cache memories may utilize different principles of locality for determining which data and/or instructions to load and store in cache memories. One type of locality is temporal locality, wherein recently used data is likely to be used again. The other type of locality is spatial locality, wherein data items stored at addresses near each other tend to be used close together in time.

Cache memories may use the principle of temporal locality in determining which cache lines are to be evicted when loading new cache lines. In many cache memories, the least recently used (i.e. accessed) cache line may be evicted from the cache when it is required to load a new cache line. Furthermore, a cache line that is the most recently used cache line may be designated as such in order to prevent it from being evicted from the cache to enable the load of another cache line. Cache memories may also include mechanisms to track the chronological order in which various cache lines have been accessed, from the most recently used to the least recently used.

The principle of spatial locality may be used by a prefetcher. More particularly, cache lines located in memory near addresses of cache lines that were recently accessed from main memory (typically due to cache misses) may be prefetched into a cache based on the principle of spatial locality. Accordingly, in addition to loading the cache line associated with the miss, cache lines that are spatially near in main memory may also be loaded into the cache and may thus be available for access from the cache by the processor in the event they are actually used. In some implementations, rather than loading the prefetched cache line into a cache, it may instead be loaded into and stored in a prefetch buffer, thereby freeing up the cache to store other cache lines. The use of a prefetch buffer may eliminate the caching of speculatively prefetched data that may not be used by the processor.

### SUMMARY OF THE DISCLOSURE

A processor having a prefetch-based promotion mechanism to reduce cache pollution is disclosed. In one embodiment, a processor includes an execution core, a cache memory, and a prefetcher coupled to the cache memory. The prefetcher may be configured to fetch a first cache line from a lower level memory and to load the cache line into the cache. Upon insertion into the cache, the first cache line is not designated as a most recently used (MRU) cache line. The cache may be configured to designate the cache line as the MRU cache line responsive to the execution core asserting N demand requests for the cache line, wherein N is an integer greater than 1.

A method is also disclosed. In one embodiment, the method includes a prefetcher prefetching a first cache line from a lower level memory. The method may further include loading the first cache line into the cache, wherein, upon insertion into the cache, the first cache line is not designated as a most recently used (MRU) cache line. The method may further include designating the first cache line as a most recently used (MRU) cache line responsive to N demand requests for the cache line, wherein N is an integer value greater than one. If fewer than N demand requests are received for the first cache line, the first cache line may be inhibited from being designated as the MRU cache line.

Another embodiment of a processor includes an execution core, a first cache configured to store a first plurality of cache lines, and a first prefetcher coupled to the first cache, wherein the first prefetcher is configured to load a first cache line into the first cache. The first cache may be a level one (L1) cache, and may be configured to designate the first cache line loaded by the first prefetcher to be a least recently used (LRU) cache line of the first cache, and wherein the first cache is configured to designate the first cache line to a most recently used (MRU) position only if the execution core requests the first cache line at least N times, wherein N is an integer value greater than 1. The processor may also include a second cache configured to store a second plurality of cache lines, wherein the second cache is a level two (L2) cache, and a second prefetcher coupled to the second cache, wherein the second prefetcher is configured to load a second cache line into the second cache. The second cache may be configured to designate the second cache line loaded by the second prefetcher to be the least recently used (LRU) cache line of the second cache. The second cache may also be configured to designate the second cache line to a most recently used (MRU) position of the second cache only if the execution core requests the second cache line at least M times, wherein M may or may not be equal to N.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a processor and a system memory;

FIG. 2 is a block diagram of one embodiment of a cache memory;

FIG. 3 is a diagram illustrating one embodiment of a cache line;

FIG. 4 is a diagram of illustrating a list for ordering cache lines from the most recently used (MRU) to the least recently used (LRU) for one embodiment of a cache;

FIG. 5 is a flow diagram of one embodiment of a method for loading a cache;

FIG. 6 is a flow diagram of another embodiment of a method for loading a cache;

FIG. 7 is a flow diagram of another embodiment of a method for loading a cache;

FIG. 8A is a diagram illustrating the operation of one embodiment of a cache configured to store prefetched data;

FIG. 8B is a diagram further illustrating the operation of one embodiment of a cache configured to store prefeteched data;

FIG. 8C is a diagram further illustrating the operation of one embodiment of a cache configured to store prefeteched data; and

FIG. 9 is a block diagram of one embodiment of a computer system.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling with the spirit and scope of the present invention as defined by the appended claims.

### DETAILED DESCRIPTION

One or more embodiments of a processor as disclosed herein may provide mechanisms to reduce cache pollution that may result from cache lines loaded by a prefetcher. Such cache lines may include data that is to be speculatively loaded into a cache memory, cache lines associated with streaming data, and so forth. Various embodiments of caches disclosed herein may use promotion policies requiring multiple demand access requests for cache lines loaded into a cache as a result of a prefetch operation. Such caches may also use a least recently used (LRU) replacement policy, wherein a cache line designated as the LRU cache line may be evicted to enable the loading of another cache line. Cache lines loaded into a cache as the result of a prefetch operation may initially be designated to have a lower priority than a most recently used (MRU) cache line, and may be designated as an LRU cache line at insertion time. Such cache lines may further require multiple demand requests (e.g., by an execution core) before they are promoted from an LRU (or other lower priority position) to the MRU position. Accordingly, cache lines that are not used may be prevented from polluting the cache by preventing cache lines that are not used (e.g., some speculatively prefetched data that is not used) or used only once (e.g., streaming data) from being placed in the MRU position. Various embodiments of such processors and methods for operating are discussed in further detail below. It is noted however, that the discussions below are of just some of the possible embodiments that may fall within the scope of this disclosure and the claims appended below.

### Processor:

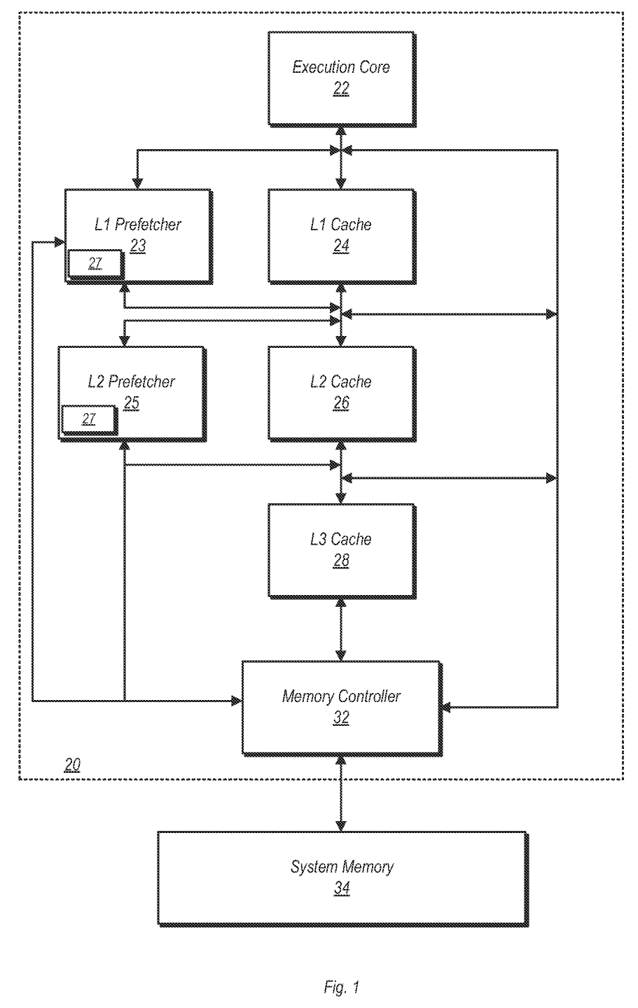

Turning now to FIG. 1, a block diagram of one embodiment of a processor and a system memory is shown. In the embodiment shown, processor 20 includes a level one (L1) cache 24, a level two (L2) cache 26, and a level three (L3) cache coupled together to form a hierarchy of cache memories, with the L1 cache being at the top of the hierarchy and the L3 cache being at the bottom. Processor 20 also includes an execution core 22 in this embodiment, which may issue demand requests for data. Responsive to demand requests issued by execution core 22, one or more of the various caches may be searched to determine if the requested data is stored therein. If the data is found in one or more of the caches, the highest-level cache may provide the data to execution core 22. For example, of the requested data is stored in all three caches in the embodiment shown, it may be provided by L1 cache 24 to execution core 22.

In one embodiment, the caches may become progressively larger as their priority becomes lower. Thus, L3 cache 28 may be larger than L2 cache 26, which may in turn be larger than L1 cache 24. It is also noted processor 22 may include multiple instances of execution core 22, and that one or more of the caches may be shared between two or more instances of execution core 22. For example, in one embodiment, two execution cores 22 may share L3 cache 28, while each execution core 22 may have separate, dedicated instances of L1 cache 24 and L2 cache 26. Other arrangements are also possible and contemplated.

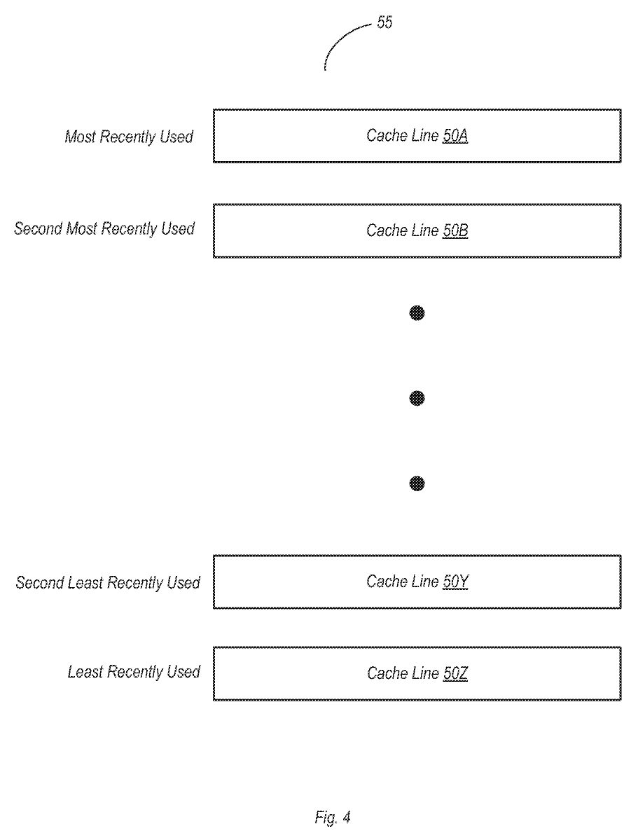

Each of the caches in the embodiment shown may use an LRU replacement policy. That is, when a cache line is to be evicted to create space for the insertion of a new cache line into the cache, the cache line designated as the LRU cache line may be evicted. Furthermore, for each of the caches in the embodiment shown, a list indicative of a priority chain may be maintained, listing the priority of each cache line. The list may track the priority of stored cache lines in descending order from the highest priority (MRU) to the lowest priority (LRU), and may be updated to reflect changes in order due to promotions, insertions, and evictions. An example of a priority chain is discussed in more detail below with reference to FIG. 4.

Processor 20 also includes a memory controller 32 in the embodiment shown. Memory controller 32 may provide an interface between processor 20 and system memory 34, which may include one or more memory banks. Memory controller may also be coupled to each of L1 cache 24, L2 cache 26, and L3 cache 28. More particularly, memory controller 32 may load cache lines (i.e. a block of data stored in a cache) directly into any one or all of L1 cache 24, L2 cache 26, and L3 cache 28. In one embodiment, memory controller 32 may load a cache line into one or more of the caches responsive to a demand request by execution core 22 and resulting cache misses in each of the caches shown. Moreover, a cache line loaded by memory controller 32 into any one of the caches responsive to a demand request may be designated, upon loading, as the most recently used (MRU) cache line.

In the embodiment shown, processor 20 also includes an L1 prefetcher and an L2 prefetcher 25. L1 prefetcher 23 may be configured to load prefetched cache lines into L1 cache 24. A cache line may be prefetched by L1 prefetcher 23 from a lower level memory, such as L2 cache 26, L3 cache 28, or system memory 34 (via memory controller 32). Similarly, L2 prefetcher 25 may be configured to load prefetched cache lines into L2 cache 26, and may prefetch such cache lines from L3 cache 28 or system memory 34 (via memory controller 34). In the embodiment shown, there is no prefetcher associated with L3 cache 28, although embodiments wherein such a prefetcher is utilized are possible and contemplated. It is also noted that embodiments utilizing a unified prefetcher to serve multiple caches (e.g., a prefetcher serving both the L1 and L2 caches) are also possible and contemplated, and that such embodiments may perform the various functions of the prefetchers that are to be described herein.

Prefetching as performed by L1 prefetcher 23 and L2 prefetcher 25 may be used to obtain cache lines containing certain types of speculative data. Speculative data may be data that is loaded into a cache in anticipation of its possible use. For example, if a demand request causes a cache line containing data at a first memory address to be loaded into a cache, at least one of prefetchers 23 and 25 may load another cache line containing data from one or more nearby addresses, based on the principle of spatial locality. In general, speculative data may be any type of data in which may be loaded into a cache based on the possibility of its use, although its use is not guaranteed. Accordingly, a cache line that contains speculative data may or may not be the target of a demand request by execution core 22, and thus may or may not be used. It should be noted that speculative data may be divided into distinct subsets, including non-streaming speculative data, streaming data, and unused data.

Streaming data may be data associated with applications wherein a steady stream of data is provided to an execution core. In various examples, streaming data may be stored in a memory or other storage at consecutive addresses or at regular address intervals. Furthermore, streaming data may be characterized in that it may, in some cases, be used only once (i.e. is the target of one demand request) in a given run of a corresponding application, but not subsequently used thereafter (however, in some cases, at least some streaming data may be re-used). Examples of streaming data may include video data, audio data, data used in highly repetitive calculations (e.g., such as the adding of a large number of operands), and so forth. The steady stream of data may be required in streaming applications to ensure that execution thereof continues forward progress, and thus may be time sensitive.

As noted above, prefetchers 23 and 25 may be used to prefetch cache lines and to load these cache lines into their corresponding caches (L1 cache 24 and L2 cache 26, respectively). In contrast to cache lines loaded into a cache by memory controller 32 responsive to demand requests and resulting cache misses, cache lines loaded into one of the caches of processor 20 by a corresponding prefetcher may be inserted into the priority chain of their respective caches in a position lower than the MRU position. Moreover, prefetched cache lines may be inserted into the priority chain at the lowest priority position, the LRU position. For example, L1 prefetcher 23 may load a cache line into L1 cache 24, wherein it may be initially inserted into the priority chain at the LRU position.

Furthermore, each of the caches associated with a prefetcher may be configured to utilize a promotion policy wherein a cache line loaded by a corresponding prefetcher requires a certain number of demand requests prior to being promoted to the MRU position in the priority chain. Broadly speaking, a cache line loaded by L1 prefetcher 23 into L1 cache 24, may require at least N demand requests before being promoted to the MRU position in the priority chain, wherein N is an integer value greater than 1 (e.g., 2, 3, 4, etc.). Similarly, a cache line loaded by L2 prefetcher 25 into L2 cache 26 may require M demand requests for promotion to the MRU position, wherein M is an integer value that may or may not be equal to N. Accordingly, cache lines initially inserted into the LRU position in their respective caches may be less likely to cause cache pollution, since they may be evicted from their respective cache (assuming the cache uses an LRU eviction policy) if not used or rarely used. In one example, a speculatively prefetched cache line that is designated as the LRU but is not the subject of a demand request may be evicted from the cache by a subsequent cache load (regardless of whether the new cache line is designated as the MRU or the LRU). In another example, a cache line containing streaming data that is the target of a single demand request may be subsequently evicted from the cache when the next cache line containing streaming data is loaded therein.

Each of prefetchers 23 and 25 may be configured to designate cache lines prefetched thereby as a prefetched cache line, and may be further configured to designate prefetched cache lines as streaming data or non-streaming speculative data. This data may be used by the corresponding one of L1 cache 24 or L2 cache 26 to determine the designation in the priority chain (e.g., as LRU) upon loading into the cache. Additional details regarding information present in various embodiments of a cache line will be discussed in further detail below.

Prefetchers 23 and 25 may also be configured to interact with their corresponding cache to determine the success of cache loads performed thereby. In the embodiment shown, each of prefetchers 23 and 25 includes a corresponding confidence counter 27. When a cache line loaded by one of prefetchers 23 and 25 is the target of a demand request by execution core 22, the corresponding cache may provide an indication the corresponding prefetcher that in turn may cause the confidence counter 27 to increment. A higher counter value for a given one of confidence counters 27 may thus provide an indication of the usefulness of cache lines loaded by a corresponding one of prefetchers 23 and 25. More particularly, a high counter value for a given confidence counter 27 may indicate a greater number of demand requests for cache lines loaded by the corresponding one of the prefetchers.

The confidence counters 27 may also be decremented in certain situations. One such situation may occur when a prefetched cache line is evicted from the corresponding cache without being the target of a demand request by an execution core 22. The eviction of the unused cache line may cause a corresponding confidence counter 27 to be decremented. Furthermore, the aging of prefetched cache lines stored in the cache may also cause a corresponding confidence counter to periodically decrement. Generally speaking, prefetched cache lines that are newer and frequently used may cause the corresponding confidence counter 27 to increment, while older and infrequently used (or unused) prefetched cache line may the corresponding confidence counter 27 to decrement.

A confidence value as indicated by a corresponding confidence counter 27 may be used to determine wherein in the priority chain some subsequently prefetched cache lines may be placed. If, for example, confidence counter 27 for a given one of prefetchers 23 and 25 has a high confidence value, cache lines prefetched by the corresponding prefetcher may receive a priority designation that is higher than LRU (but less than MRU) upon insertion into the cache. In some embodiments, a high confidence value indicated by a confidence counter 27 may also be used to determine the number of demand requests required to promote a prefetched cache line to the MRU position in the priority chain. For example, if a confidence counter 27 indicates a high confidence value, the threshold for promoting a prefetched cache line to the MRU position in the priority chain for one embodiment may be set at two demand requests instead of three demand requests for a cache line loaded when the confidence value is low. Generally speaking, the use of confidence counters 27 may aid in the reduction of cache pollution, as the confidence value may provide an indication of the likely usefulness of prefetched cache lines. It should be noted that in some embodiments, confidence counters may instead be implemented within circuitry of a cache instead of in prefetchers 23 and 25. In some embodiments, one or both of prefetchers 23 and 25 may include multiple confidence counters, each of which may be associated with a subset of its internal mechanisms or state such that different prefetched lines may be assigned different confidence levels based on the mechanism and/or state which was used to generate their respective prefetches.

Prefetchers 23 and 25 may also be configured to generate and provide indications as to whether or note certain cache lines are easily prefetchable. Cache lines that are deemed to be easily prefetchable may be given a lower priority in the priority chain (e.g., may be designated as the LRU upon insertion into a cache). The eviction of easily prefetchable cache lines from a cache may be less likely to cause performance degradation, since such lines may be easily prefetched again.

Certain types of cache lines may be more easily prefetchable than others. For example, cache lines associated with streaming data may be more easily prefetchable than some other types of cache lines. Those cache lines that are associated with streaming data may be easily identifiable based on streaming behavior of the program associated therewith. Accordingly, processor 20 may be configured to indicate whether or not particular prefetched cache lines are associated with a program that exhibits streaming behavior. Such cache lines may be identified as such by a corresponding one of prefetchers 23 and 25. When a cache line associated with streaming data is inserted into L1 cache 24 or L2 cache 26 in the embodiment shown, it may be placed lower in the priority chain (e.g., at the LRU position), and may be inhibited from being promoted to the MRU position unless it is the target of multiple demand requests (e.g., two or more). Since many cache lines associated with streaming data are typically used only once before being evicted from a cache, prioritizing such cache lines as the LRU cache line in the priority chain may prevent them from remaining in the cache after their usefulness has expired as they may be evicted from the cache when the next prefetched cache line is inserted.

Cache lines prefetched by a stride prefetcher (or by a prefetcher configured to function as a stride prefetcher) may also be considered as easily prefetchable cache lines. Stride prefetching may involve the examination of addresses of data requested by a program over time. If these addresses consistently spaced apart from one another (i.e. a regular “stride”), then a stride prefetcher may begin prefetching cache lines that include data at the regularly spaced addresses. Thus, in one embodiment, execution core 22 may provide an indication to a corresponding one of prefetchers 23 and/or 25 to indicate that the addresses of requested data are spaced as regular intervals from one another. Responsive thereto, prefetchers 23 and 25 may perform stride prefetching by prefetching cache lines from regularly space address intervals. Cache lines prefetched as part of a stride prefetching operation may be easily prefetched again in the event of their early eviction from a cache. Accordingly, cache lines prefetched when prefetchers 23 and/or 25 are operating as stride prefetchers may be inserted into their respective caches at the LRU position in the priority chain, and may require multiple demand requests before being promoted to the MRU position.

Some cache lines that are not easily prefetchable, but are not critical to program operation in terms of latency may also be inserted into the cache with a low priority, and may further require multiple demand requests before being promoted to the MRU position in the priority chain. For example, a cache line may include data that is not to be used by a given program for a long period of time. Therefore, the program may be able to tolerate a long latency access of the cache line since a low latency access of the same cache line is not required for the program to continue making forward progress. Accordingly, such cache lines may, if cached, be inserted into one of the caches 24, 26, or 28 with low priority.

As previously noted, memory controller 32 may be configured to directly insert cache lines into any one of caches 24, 26, or 28 in the embodiment shown. More particularly, memory controller 32 may be configured to insert a cache line into one of caches 24, 26, and/or 28 responsive to a demand request and a subsequent cache miss. For example, if a demand request results in an L1 cache miss, memory controller 32 may obtain the requested cache line from system memory, or the cache line may be obtained from a lower level cache (e.g., an L2 cache or L3 cache). The cache line may then be inserted into L1 cache 24 at the MRU position in the priority chain. Furthermore, even after such a cache line is displaced as the MRU, it may require only one subsequent demand request in order to be promoted to the MRU position again.

In contrast, cache lines loaded into a corresponding cache by one of prefetchers 23 and 25 may be inserted into the priority chain with a priority lower than that of the MRU. In many cases, cache lines loaded by one of prefetchers 23 and 25 may be inserted into the corresponding cache at the LRU position in the priority chain. Furthermore, such cache lines may require multiple demand requests before they are promoted to the MRU position. Since caches 24 and 26 may utilize an LRU replacement policy, cache lines that are inserted by one of prefetchers 23 or 25 into the LRU position and are subsequently unused may be evicted from the corresponding cache upon insertion into the cache of another cache line. This may prevent at least some unused cache lines from remaining in the cache for long periods of time. Furthermore, since prefetched cache lines may require multiple demand requests before being promoted to the MRU position in the priority chain, prefetched cache lines that are used only once may be prevented from remaining in the cache over time. Thus, speculatively loaded cache lines, cache lines associated with streaming data, cache lines prefetched during stride prefetching operations, and other types of prefetched cache line may be less likely to cause cache pollution by being inserted into a cache with a low priority (e.g., at the LRU position) and with a requirement of multiple demand requests before being promoted to the MRU position. In effect, prefetchers 23 and 25 may provide a filtering function in order to distinguish prefetched cache lines from other cache lines that are not loaded as the result of a prefetch.

It is also noted that processor 20 does not include prefetch buffers in the embodiment shown. In some prior art embodiments, prefetch buffers may be used in conjunction with prefetchers in order to provide temporary storage for prefetched data in lieu of caching the data. However, by using the prefetchers to distinguish prefetched cache lines from non-prefetched cache lines, and by prioritizing and promoting prefetched cache lines as discussed herein, storing prefetched cache lines in one or more caches may eliminate the need for prefetch buffers. Furthermore, the hardware savings obtained by elimination of prefetch buffers may allow for larger cache sizes in some embodiments.

### Cache Memory:

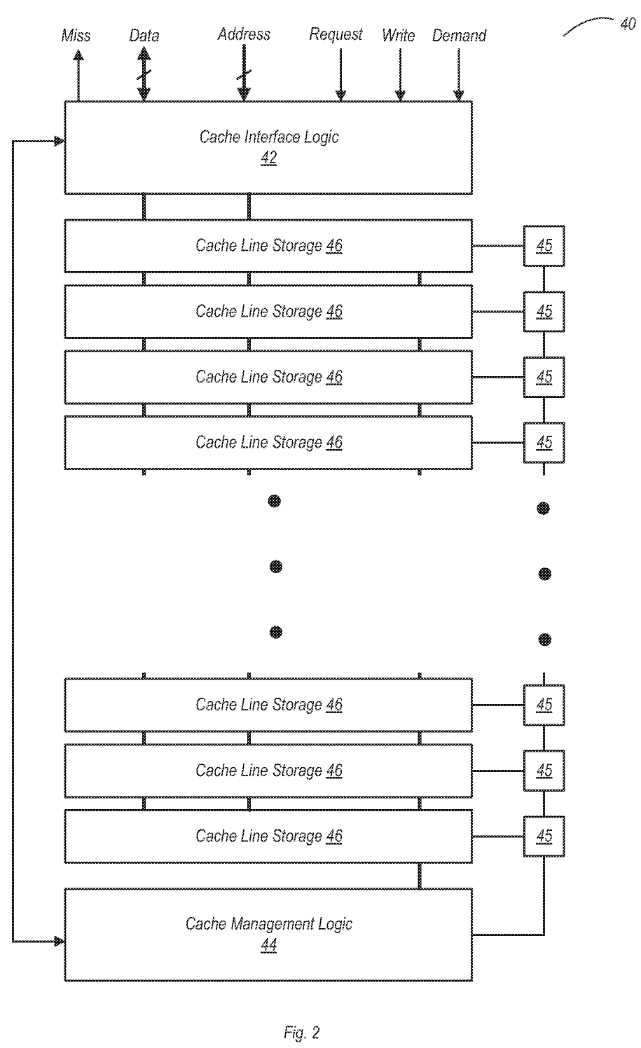

Turning now to FIG. 2, a block diagram of one embodiment of a cache memory is shown. In the embodiment shown, cache 40 may be equivalent to any one of caches 24, 26, or 28 shown in FIG. 1. Accordingly, cache 40 may be an L1 cache, and L2 cache, and L3 cache, or any other level cache that may be implemented in a processor based system.

In the embodiment shown, cache 40 includes cache interface logic 42, which is coupled to each of a plurality of cache line storage locations 46. Each of the cache line storage locations 46 in this embodiment is also coupled to a cache management logic unit 44. Furthermore, each cache storage location 46 in the embodiment shown is also coupled to a corresponding one of a plurality of promotion counters 45.

Cache interface logic 42 may provide an interface between an execution core and the cache line storage locations 46. In accordance with processor 20 shown in FIG. 1, cache interface logic 42 may also provide an interface between cache line storage locations 46 and a prefetcher (e.g., prefetcher 23 coupled to L1 cache 24). Requests for access to read or write to cache 40 may be made by asserting the ‘request’ line coupled to cache interface logic unit 42. If the request is a write request (i.e. to write a cache line into the cache), the ‘write’ line may also be asserted. The cache line to be written into one of cache line storage locations 46 may be conveyed to cache interface logic 42 via the ‘data’ lines shown in the drawing. Some address information identifying the cache line (e.g., a logical address or portion thereof) may also be provided to cache interface logic 42. During the insertion of a new cache line, cache interface logic may also communicate with cache management logic 44 to determine the location of the cache line to be replaced. In one embodiment, cache 40 may utilize an LRU replacement policy, wherein the cache line that is designated at the LRU cache line is replaced when a new cache line is to be loaded. Accordingly, cache interface logic 42 may query cache management logic 44 to determine in which cache line storage location 46 the currently designated LRU cache line is stored. Cache management logic 44 may return the requested information to cache interface logic 42, which may then write the new cache line into the indicated cache line storage location 46. Cache interface logic 42 may also enable the writing of an individual data word to a cache line when the execution of a particular instruction modifies that data word.

Cache interface logic 42 may also be configured to search for a requested cache line responsive to a demand request by an execution core. In the embodiment shown, a demand request may be indicated to cache interface logic 42 when both the ‘request’ and ‘demand’ lines are asserted. Cache interface logic 42 may also receive address information via the address lines along with the demand request, where the address information may include at least a portion of a logical address of the requested data. This address information may be used to identify the cache line containing the requested data. In other embodiments, other types of identifying information may be provided to identify cache lines. Responsive to receiving the demand request and the address information, cache interface logic 42 in the embodiment shown may search the among the cache line storage locations 46 to determine whether the cache line containing the requested data is located stored in the cache. If the search does not locate the cache line containing the requested data, cache interface logic 42 may assert a signal on the ‘miss’ line, which may cause a lower level memory (e.g., a lower level cache, system memory, or storage) to be searched. If the cache line containing the requested data is found in a cache line storage location 46, the requested data may be read and provided to the requesting execution core via the data lines shown in FIG. 2.

Cache management logic 44 may perform various functions, including maintaining a list indicating the priority chain for each of the cache lines stored in cache 40. The list may prioritize cache lines from the MRU cache line (highest priority) to the LRU cache line (lowest priority). The priority chain list may be updated according to changes in priority, including when a new cache line is loaded (and thus another cache line is evicted), and when a cache line is promoted to the MRU position. Cache management logic 44 may further be configured to determine when a newly loaded cache line has been loaded responsive to a prefetch operation (i.e. loaded by a prefetcher) or responsive to a demand request. In one embodiment, cache management logic 44 may be configured to initially designate a prefetched cache line as the LRU cache line, while designating a cache line loaded responsive to a demand request as the MRU cache line. Examples illustrating the maintenance and updating of the priority chain list as performed by an embodiment of cache management logic 44 will be discussed in further detail below.

In the embodiment shown, cache 40 includes a plurality of promotion counters 45, each of which is associated with a corresponding one of the cache line storage locations 46. Thus, a promotion counter 45 is associated with each of the cache lines stored in cache 40. As previously noted, cache lines loaded into a cache, such as cache 40, by a prefetcher (e.g., prefetchers 23 and 25 of FIG. 1) may require a certain number of demand requests before being promoted to the MRU position in the priority chain. More particularly, a cache line loaded by a prefetcher may require N demand requests before promotion to the MRU position, wherein N is an integer value greater than 1.

In one embodiment, a promotion counter 45 may be set to a value of N−1 when a recently prefetched cache line is loaded into the corresponding cache line storage unit 46. For each demand request for the prefetched cache line, the corresponding promotion counter 45 may be queried by cache management logic 44 to determine whether or not its corresponding count is a non-zero value. If the count value is not zero, cache management logic 44 may inhibit the cache line from being promoted to the MRU position in the priority chain. If the demand request is the N^{th} demand request, as indicated by the count value being zero, cache management logic 44 may promote the corresponding cache line to the MRU position. The corresponding promotion counter 45 may also be decremented responsive to a demand request for that cache line.

In another embodiment, rather than decrementing, a given promotion counter may be incremented (starting at a value of zero) for each demand request of a prefetched cache line, with cache management logic 44 comparing the count value to a value of N−1. When a demand access request causes the count value to reach N−1, the cache line may be promoted to the MRU position.

In some embodiments, in lieu of individual counters for each of the cache line storage locations, cache 40 may include registers or other types of storage in which to store a count indicating the number of times each stored cache line has been the target of a demand request. Generally speaking, cache 40 may employ any suitable mechanism for tracking the number of demand requests for each of the stored cache lines, along with a comparison mechanism for comparing the number of demand requests to a promotion threshold. In yet another alternative embodiment, cache 40 may instead provide a counter only for the LRU position in the priority chain, and thus the threshold value in such an embodiment may apply only to the cache line having the LRU designation.

It should also be noted that some embodiments of cache 40 may include a confidence counter (similar to confidence counter 27 discussed above) implemented therein. For example, a confidence counter could be implemented within cache management logic 44 in one embodiment. In another embodiment, cache management logic 44 may include one or more registers or other type of storage that may store the current value of a confidence counter 27 located in a corresponding prefetch unit.

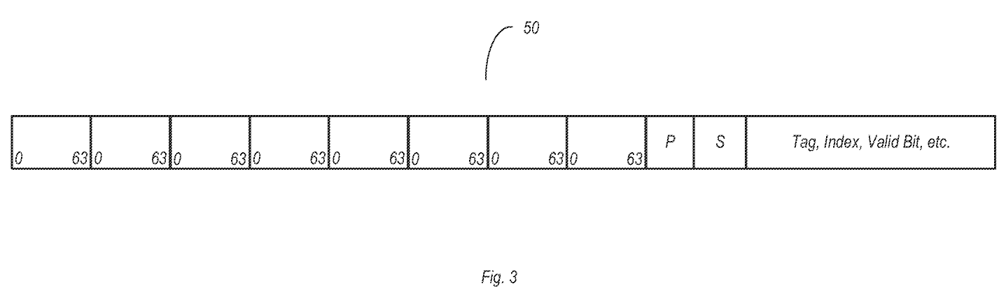

FIG. 3 illustrates one embodiment of a cache line that may be stored in a cache line storage location 46 of cache 40. In the embodiment shown, cache line 50 includes eight 64-bit data words and additional fields that may carry information concerning the cache line. In other embodiments, the number and size of the words in the cache line may be different than that shown here. Cache line 50 also includes a ‘P’ field and an ‘ S’ field, to be discussed below. In some embodiments, these fields may be conveyed with the cache line to the cache, but are not stored in the cache thereafter.

In the embodiment shown, cache line 50 includes a ‘P’ field that may be used to indicate whether or not the cache line was prefetched or not. The ‘P’ field may be set (e.g., a logic 1) if the cache line was inserted to the cache by a prefetcher. Otherwise, if the cache line was inserted into the cache line by a memory controller or other functional unit, the ‘P’ field may be in a reset state (e.g., logic 0). A prefetcher (e.g., prefetcher 23 or 25 of FIG. 1) may set the ‘P’ field after prefetching from a lower level memory and just prior to insertion into the corresponding cache. Cache management logic 44 may detect whether or not the ‘P’ field is set to determine where in the priority chain the cache line is to be inserted. A newly loaded cache line 50 may initially be designated as the MRU cache line if cache management logic 44 detects that the ‘P’ field is in a reset state. Otherwise, the newly loaded cache line 50 may be designated with a lower priority. In one embodiment, all prefetched cache lines 50 may initially be designated as the LRU cache line upon insertion into the cache. In other embodiments, additional information may be considered in determining where in the priority chain a prefetched cache line 50 is to be inserted.

In the embodiment shown, cache line 50 includes an ‘S’ field that may be used to determine whether a prefetched cache line 50 includes streaming data or speculative data. In embodiments that include the ‘S’ field, cache management logic 44 may use the information contained therein to determine where in the priority chain to insert the cache line 50. Upon prefetch of a cache line 50, a prefetcher, such as prefetcher 23 or 25, may set the ‘ S’ field to a first logic value (e.g., logic 1) if the prefetched cache line 50 includes streaming data, and may set the ‘S’ field to a second logic value (e.g., logic 0) if the prefetched cache line includes speculative data. Upon insertion into cache 40, cache management logic 44 may query the ‘ S’ field if the ‘P’ field indicates that the cache line 50 is a prefetched cache line.

In one embodiment, if the ‘S’ field indicates that streaming data is present in cache line 50, cache management logic 44 may insert cache line 50 into the priority chain in the LRU position. Since streaming data is typically used only once before being evicted from the cache, inserting cache line 50 into the LRU position in the priority chain may allow the streaming data to be accessed once before being evicted from cache 40.

If the ‘S’ field indicates that cache line 50 includes speculative, non-streaming data, cache management logic 44 may query the confidence counter 27 of the corresponding prefetch unit 23 or 25. In another embodiment, cache management logic 44 may query a confidence counter contained therein, or a register storing the confidence value. Based on the confidence value, cache management logic 44 may determine where in the priority chain cache line 50 is to be inserted. In one embodiment, cache management logic 44 may insert the cache line 50 into the LRU position of the priority chain if the confidence value is low or zero, since a low confidence value may indicate that cache line 50 is less likely to be the target of a demand request. If the confidence value is high, cache management logic unit 44 may insert cache line 50 higher up in the priority chain (although not at the MRU position), since a higher confidence value may indicate a higher likelihood that cache line 50 will be the target of a demand request.

In some embodiments, cache management logic 44 may utilize multiple thresholds to determine where in the priority chain to insert a cache line 50 including speculative data. For example, if the confidence value is less than a first threshold, cache management logic 44 may insert a cache line 50 having speculative data in the LRU position of the priority chain, while inserting cache line 50 at a second most recently used position if the confidence value is equal or greater than the first threshold. If the confidence value is equal to or greater than a second threshold, cache management logic 44 may insert the cache line 50 in the next higher priority position, and so forth.

It should be noted that the ‘S’ field is optional, and thus embodiments of cache line 50 are possible and contemplated wherein no ‘S’ field is included. In such embodiments, a prefetched cache line 50 may be assigned to the LRU position in the priority chain without cache management logic 44 considering inserting the cache line into a higher priority position based on a confidence value. It should also be noted that in cache logic management 44 may ignore the ‘S’ field when the ‘P’ field for a given cache line 50 indicates that the cache line 50 is not a prefetched cache line for embodiments in which the ‘S’ field is implemented.

Cache line 50 also includes other information fields in the embodiment shown. These fields may include, but are not limited to, a tag field, an index field, a valid bit, and so forth. Information included in these fields may be used to identify the cache line 50, indicate whether or not the cache line contains a ‘dirty’ (i.e. modified) entry, and so forth.

FIG. 4 illustrates one embodiment of a priority chain that may be maintained and updated by cache management logic 44. In the embodiment shown, priority chain 55 is a list that tracks the priority of cache lines store in cache 40, from the highest priority (MRU) to the lowest priority (LRU). In this example, cache line 50A is in the MRU position, while cache line 50Z is in the LRU position. Cache line 50B is in the second most recently position in the embodiment shown, while cache line 50Y is in the second least recently position. A plurality of cache lines may also be present between those discussed here, in a descending order of priority.

Cache management logic 44 may re-order the list responsive to cache hits and the insertion of new cache lines. For example, if cache line 50B is the target of a demand request, it may be promoted to the MRU position, while cache line 50A may be pushed down to the second MRU position. In another example, if a new cache line 50 is to be inserted by memory controller 32, each cache line 50 may be pushed down in the priority chain, with the new cache line 50 being inserted at the MRU position, while cache line 50Z may be evicted from the LRU position (which is assumed by cache line 50Y). In a third example, the cache line in the LRU position of the priority chain (cache line 50Z in this case) may be evicted when a prefetcher inserts a new cache line. In a fourth example, a prefetched cache line 50 initially inserted into the LRU position may be promoted to the MRU position if it is the target of N demand requests, thereby pushing the remainder of the cache lines down by one increment in the priority chain. For each of these examples, cache management logic 44 may re-order the list to reflect the changes to the priority chain.

While the embodiment shown in FIG. 4 illustrates a given ordering for the cache lines 50 in the priority chain, it should be noted that this is not meant to imply any particular physical configuration. Thus, any cache line may be designated as being in a certain position within the priority chain regardless of the actual physical location of the corresponding cache line storage location 46 within cache 40.

### Method Flow:

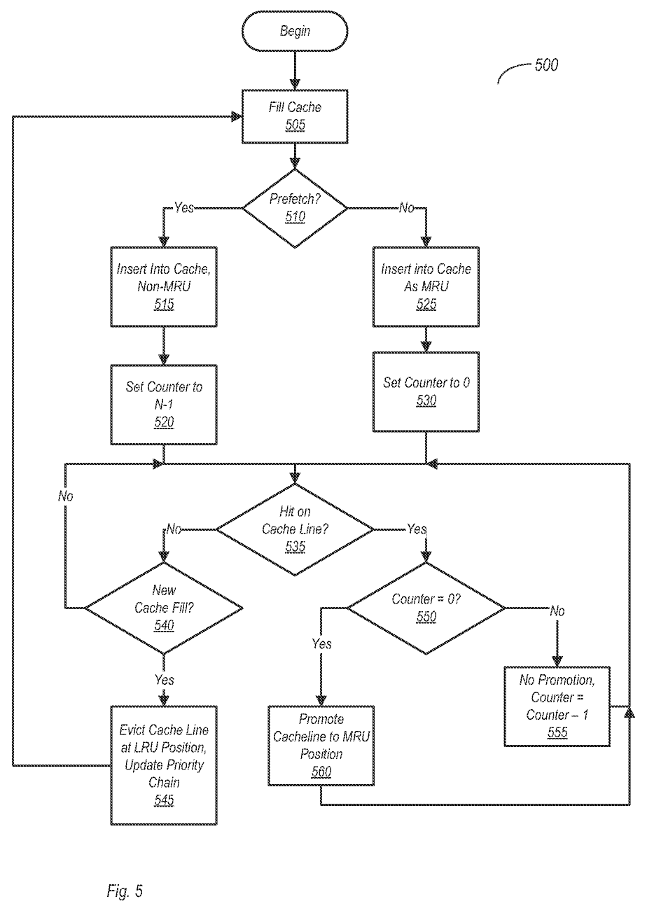

FIGS. 5-8 illustrate various embodiments of methods for inserting into a cache and promoting the cache lines within the hierarchy of a priority chain. The methods discussed herein may be performed by the embodiments discussed above, as well as by other embodiments not explicitly disclosed herein.

Turning now to FIG. 5, a flow diagram of one embodiment of a method for loading a cache is shown. In the embodiment shown, method 500 begins with the cache fill, i.e. a load of a cache line into a cache (block 505). Upon loading of the cache line, a determination may be made as to whether or not the cache line is a prefetched cache line (block 510). If the cache line is a prefetched cache line (block 510, yes), it may be inserted into the priority chain of the cache in a position other than the MRU position (block 515). When a prefetched cache line is inserted into the priority chain with a priority lower than that of the MRU position, a corresponding promotion counter may be set to a value of N−1 (block 520), wherein N is a threshold value indicating the number of demand requests required before that cache line may be promoted to the MRU position. The value of N may be an integer value greater than one. For example, in one embodiment, N=2, and thus at least two demand requests are required before that cache line may be promoted to the MRU position.

If the cache line is not a prefetched cache line (block 510, no), then it may be inserted into the priority chain at the MRU position (block 525). Furthermore, the promotion counter associated with that cache line may be set to 0 (block 530). Thus, if the cache line falls in priority, it may again be promoted to the MRU position responsive to a single demand request.

If a cache hit occurs resulting from a demand request for the cache line (block 535, yes), then the promotion counter may be queried. If the counter value indicates a value of 0 (block 550, yes), then the cache line may be promoted to the MRU position (block 560) if not already designated as such. If the counter value is has a non-zero value (block 550, no), then the cache line is not promoted, and the counter is decremented (block 555).

If no demand request has occurred for the cache line and thus no cache hit for that line (block 535, no), and a new cache fill occurs (block 540, yes), then the cache line at the LRU position may be evicted and the priority chain may be updated accordingly (block 545), along with the insertion of the new cache line (block 505).

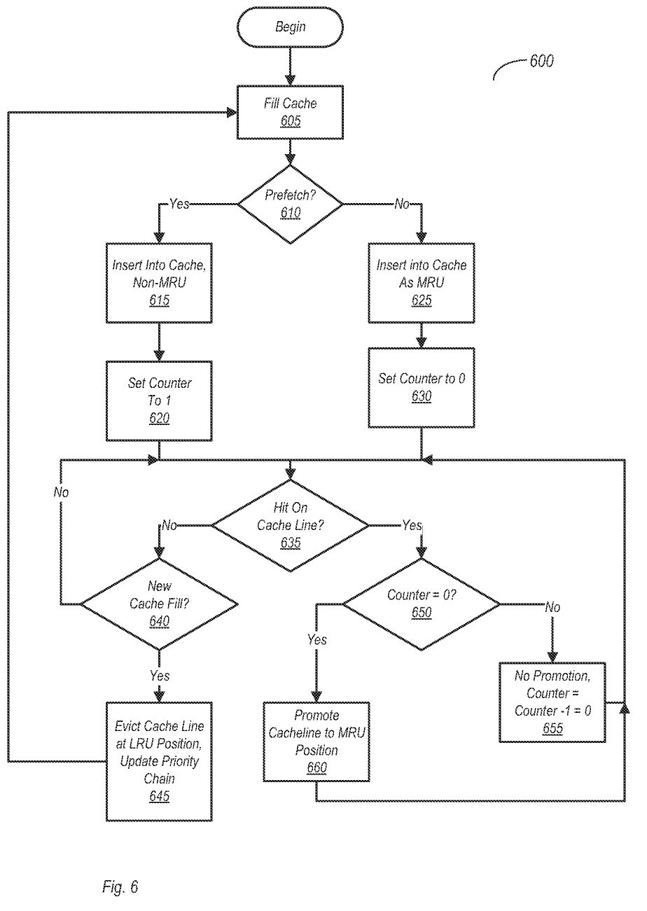

The method illustrated by FIG. 6 is similar to that illustrated in FIG. 5. However, in this embodiment the promotion threshold N=2. Accordingly, for a prefetched cache line inserted into a non-MRU position in the priority chain, the promotion counter may be set to a value of 1 (block 620), since N−1=1 in this case. Thus, two demand requests for the same cache line in this embodiment may trigger the promotion of a prefetched cache line to the MRU position. Thus, after a first demand request for the prefetched cache line, the promotion counter is decremented to 0 (block 655). Otherwise, method 600 is largely equivalent to method 500.

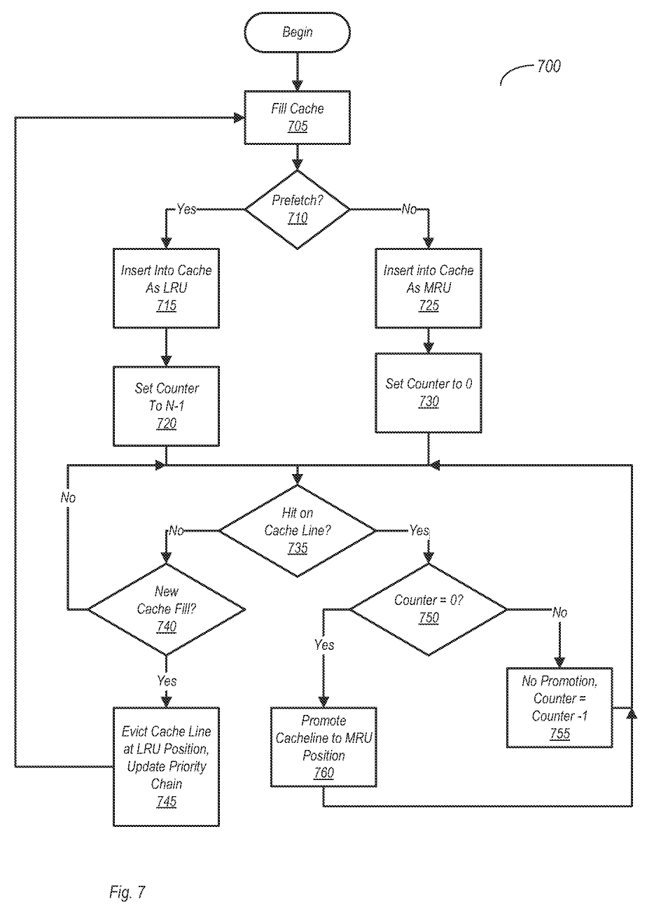

Method 700 of FIG. 7 is also similar to method 500 of FIG. 5, except in that all prefetched cache lines are inserted into the LRU position of the priority chain (block 715) in this embodiment. Otherwise, method 700 is largely equivalent to method 500. Method 700 may be suitable for use with embodiments wherein no confidence counter is used, and thus where all prefetched cache lines are automatically inserted into the LRU position when loaded into the cache.

### Illustrative Examples of Insertion, Promotion, and Eviction of Cache Lines:

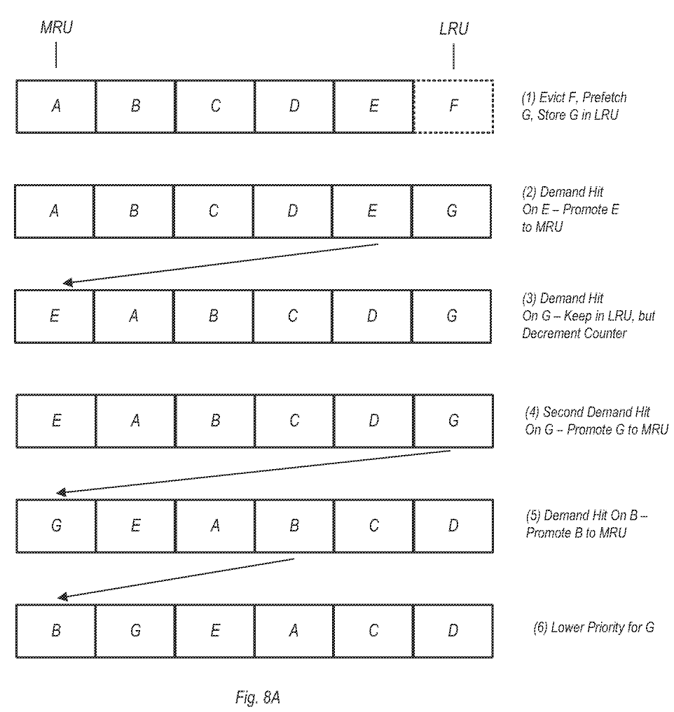

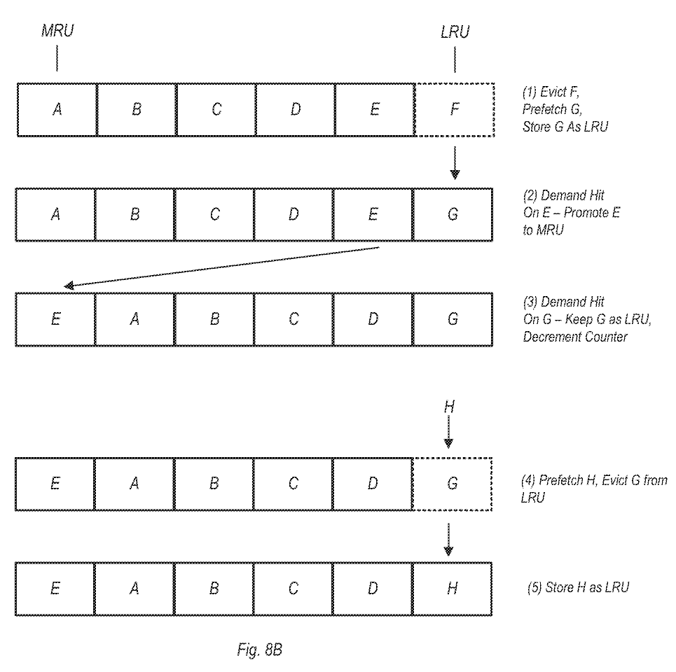

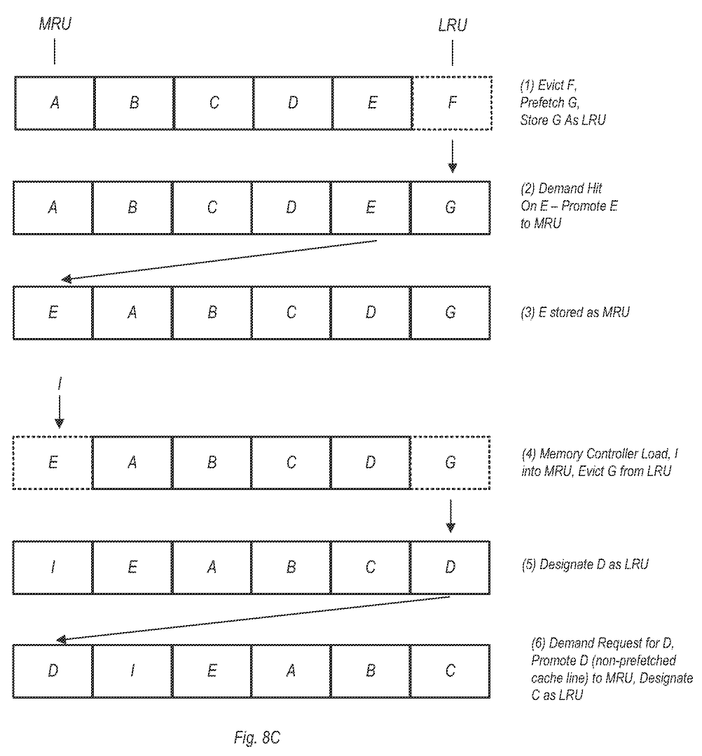

FIGS. 8A-8C illustrate the insertion and promotion policies for one embodiment of a processor in which a prefetcher may insert a cache line into a corresponding cache. More particularly, FIGS. 8A-8C may be used to illustrate the affect on the priority chain of various types of cache loads and cache line promotions within the priority chain. The examples may illustrate the operation for various embodiments of the processor, caches, and other functional units discussed above, and may further be applied to other embodiments not explicitly discussed herein. In these particular examples, it is assumed that N=2 (i.e. two demand requests are required to promote a prefetched cache line to the MRU position) that all prefetched cache lines are initially inserted into the LRU position of the priority chain, and that the cache line in the LRU position is replaced when another cache line is loaded into the cache. However, it should be understood embodiments having different promotion policies (e.g., N=3) and different insertion policies (e.g., cache lines may be inserted into the priority chain at position with higher priority than the LRU position), and different replacement policies, are possible and contemplated. It should further be noted that some steps may be performed concurrently, despite any particular order that may be implied (e.g., the insertion of a cache line and the eviction of another cache line may be performed concurrently, with the new cache line overwriting the cache line to be replaced).

Turning now to FIG. 8A, a diagram illustrating the operation of one embodiment of a cache configured to store prefetched data is shown. More particularly, FIG. 8A illustrates one embodiment of a cache insertion and promotion policy for a prefetched cache line. This particular example begins with a cache having a priority hierarchy beginning with cache line A stored in the MRU position and cache line F stored in the LRU position. Cache lines B, C, D, and E are stored, in descending order of priority, between the MRU and LRU positions at the beginning of this example.

In (1), cache line F is evicted from the cache, and thus the LRU position, while G is prefetched and stored in the cache in the LRU position of the priority chain. In (2), a cache hit based on a demand request for cache line E may occur, thus causing its promotion to the MRU position. When cache line E is promoted to the MRU position cache lines A, B, C, and D are all demoted by one increment in the priority chain.

In (3), a demand request for cache line G results in a cache hit. However, since only one demand request for cache line G has occurred, it is not promoted, instead remaining in the LRU position of the priority chain. However, in (4), a second demand request for cache line G results in a cache hit. Thus, since N=2 in this embodiment, cache line G may be promoted to the MRU position of the priority chain. The promotion of cache line G to the MRU position in turn may cause cache lines E, A, B, C, and D to be demoted by one increment. In (5) a demand request for cache line B results in a hit. Accordingly, cache line B is promoted to the MRU position, while cache lines G, E, and A are each demoted by one increment in the priority chain.

FIG. 8B is an example illustrating another scenario. The example shown in FIG. 8B begins as that of FIG. 8A, with cache line A in the MRU position and cache line F in the LRU position. In (1), cache line G is prefetched, and thus cache line F may be evicted from the LRU, with cache line G being inserted into the priority chain in the LRU position. In (2), a cache hit results from a demand request for cache line E. Responsive to the demand request and the resulting cache hit, cache line E may be promoted to the MRU position, with cache lines A, B, C, and D being demoted by one increment, while cache line G remains in the LRU position. In (3) a demand request for cache line G results in a cache hit. However, cache line G may remain in the LRU position, since this is only the first demand request of two required for promotion to the MRU position. In (4), cache line H is prefetched to be loaded into the cache. Since the cache in this example utilizes an LRU replacement policy, cache line G is evicted, and in (5) cache line H is stored in the cache, in the LRU position in the priority chain.

The scenario illustrated in FIG. 8B may occur with prefetched cache lines that include streaming data. Since streaming data may be used only a single time, a cache line including the same may be prefetched into the cache in order to make the streaming data readily available for the execution core that is executing the program having streaming behavior. Since cache lines that are used only once are not promoted in this embodiment, such cache lines may be evicted from the cache without ever being promoted from the LRU position, thereby preventing them from remaining in the cache unused for long periods of time. It should also be noted that cache line H in this example may also include the next required block of streaming data to be used by the program. Accordingly, the example illustrated in FIG. 8B may repeat itself multiple times for the execution of a program that exhibits streaming behavior.

The example of FIG. 8C may be used to illustrate the effect of prefetched cache lines that are unused, and thus not the target of any demand requests. As with FIGS. 8A and 8B, FIG. 8C begins with cache line A in the MRU position, cache line F in the LRU position, and cache lines B, C, D, and E in descending order between the MRU and LRU positions. In (1), cache line F is evicted and cache line G is loaded into the cache, being inserted into the LRU position of the priority chain. In (2), a demand request for cache line E results in a hit, thereby causing the promotion of E to the MRU position in the priority chain. In (3), E holds the MRU position in the priority chain, while G holds the LRU position. In (4), responsive to a demand request and a cache miss, a memory controller loads cache line I into the cache, inserting it in the MRU position of the priority chain. Cache lines A, B, C, and D may be demoted by one increment in the priority chain, while cache line G is evicted from the cache. Thus, cache line G is evicted from the cache as unused. In (5), cache line D is placed in the LRU position in the priority chain after the eviction of cache line G. In (6), a demand request for cache line D and resulting cache hit causes its promotion to the MRU position, and further causes the demotion by one increment for each of cache lines I, E, A, B, and C.

The above examples illustrate a few of many possible scenarios that may fall within the scope of the embodiments of a method and apparatus disclosed herein. Generally speaking, prefetched cache line may be inserted into the cache in the LRU position of the priority chain, or with a priority that is relatively low with respect to the MRU position. In contrast, non-prefetched cache lines that are loaded as a result of a demand request and a cache miss may be inserted into the MRU position. Prefetched cache lines may also require multiple demand requests before being promoted to the MRU position, thereby preventing infrequently used (or unused) cache lines from remaining in the cache for extended time periods.

### Computer System

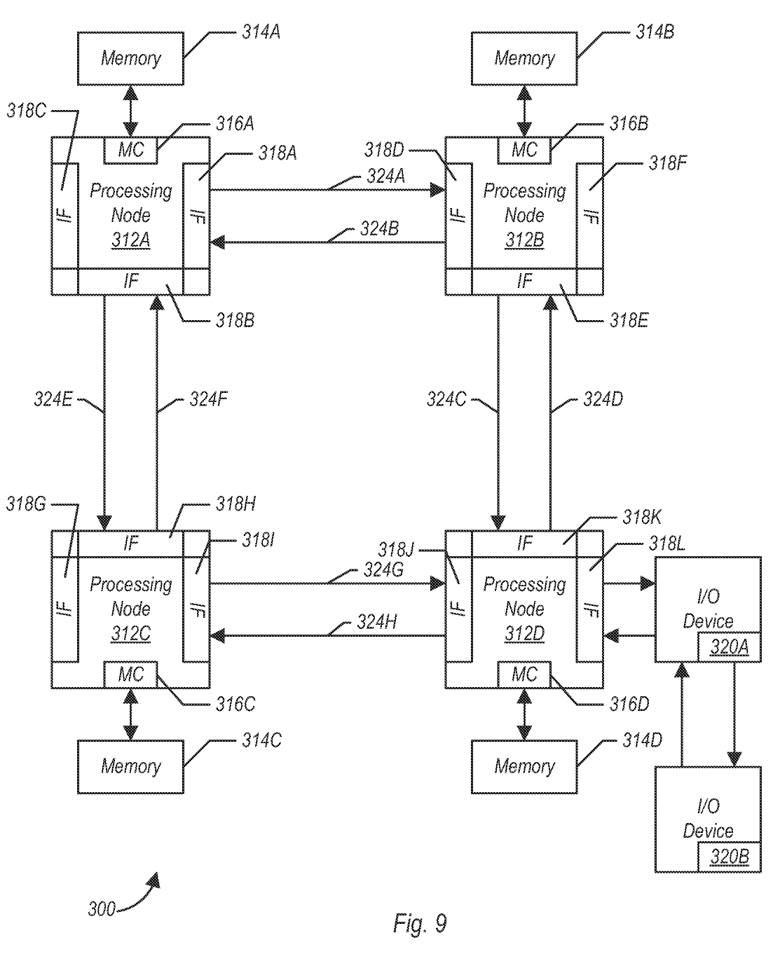

Turning now to FIG. 9, an embodiment of a computer system 300 is shown. In the embodiment of FIG. 9, computer system 300 includes several processing nodes 312A, 312B, 312C, and 312D. Each processing node is coupled to a respective memory 314A-314D via a memory controller 316A-316D included within each respective processing node 312A-312D. Memory controllers 316A-316D may be equivalent to memory controller 32 shown in FIG. 1. Similarly, memories 314A-314D may be equivalent to memory 34 also shown in FIG. 1. Additionally, processing nodes 312A-312D include interface logic used to communicate between the processing nodes 312A-312D. For example, processing node 312A includes interface logic 318A for communicating with processing node 312B, interface logic 318B for communicating with processing node 312C, and a third interface logic 318C for communicating with yet another processing node (not shown). Similarly, processing node 312B includes interface logic 318D, 318E, and 318F; processing node 312C includes interface logic 318G, 318H, and 318I; and processing node 312D includes interface logic 318J, 318K, and 318L. Processing node 312D is coupled to communicate with a plurality of input/output devices (e.g. devices 320A-320B in a daisy chain configuration) via interface logic 318L. Other processing nodes may communicate with other I/O devices in a similar fashion.

Processing nodes 312A-312D implement a packet-based link for inter-processing node communication. In the present embodiment, the link is implemented as sets of unidirectional lines (e.g. lines 324A are used to transmit packets from processing node 312A to processing node 312B and lines 324B are used to transmit packets from processing node 312B to processing node 312A). Other sets of lines 324C-324H are used to transmit packets between other processing nodes as illustrated in FIG. 9. Generally, each set of lines 324 may include one or more data lines, one or more clock lines corresponding to the data lines, and one or more control lines indicating the type of packet being conveyed. The link may be operated in a cache coherent fashion for communication between processing nodes or in a noncoherent fashion for communication between a processing node and an I/O device (or a bus bridge to an I/O bus of conventional construction such as the Peripheral Component Interconnect (PCI) bus or Industry Standard Architecture (ISA) bus). Furthermore, the link may be operated in a non-coherent fashion using a daisy-chain structure between I/O devices as shown. It is noted that a packet to be transmitted from one processing node to another may pass through one or more intermediate nodes. For example, a packet transmitted by processing node 312A to processing node 312D may pass through either processing node 312B or processing node 312C as shown in FIG. 9. Any suitable routing algorithm may be used. Other embodiments of computer system 300 may include more or fewer processing nodes then the embodiment shown in FIG. 9.

Generally, the packets may be transmitted as one or more bit times on the lines 324 between nodes. A bit time may be the rising or falling edge of the clock signal on the corresponding clock lines. The packets may include command packets for initiating transactions, probe packets for maintaining cache coherency, and response packets from responding to probes and commands.

Processing nodes 312A-312D, in addition to a memory controller and interface logic, may include one or more processors. Broadly speaking, a processing node comprises at least one processor and may optionally include a memory controller for communicating with a memory and other logic as desired. More particularly, each processing node 312A-312D may comprise one or more copies of processor 10 as shown in FIG. 1 (e.g. including various structural and operational details shown in FIGS. 2-5). One or more processors may comprise a chip multiprocessing (CMP) or chip multithreaded (CMT) integrated circuit in the processing node or forming the processing node, or the processing node may have any other desired internal structure.

Memories 314A-314D may comprise any suitable memory devices. For example, a memory 314A-314D may comprise one or more RAMBUS DRAMs (RDRAMs), synchronous DRAMs (SDRAMs), DDR SDRAM, static RAM, etc. The address space of computer system 300 is divided among memories 314A-314D. Each processing node 312A-312D may include a memory map used to determine which addresses are mapped to which memories 314A-314D, and hence to which processing node 312A-312D a memory request for a particular address should be routed. In one embodiment, the coherency point for an address within computer system 300 is the memory controller 316A-316D coupled to the memory storing bytes corresponding to the address. In other words, the memory controller 316A-316D is responsible for ensuring that each memory access to the corresponding memory 314A-314D occurs in a cache coherent fashion. Memory controllers 316A-316D may comprise control circuitry for interfacing to memories 314A-314D. Additionally, memory controllers 316A-316D may include request queues for queuing memory requests.

Generally, interface logic 318A-318L may comprise a variety of buffers for receiving packets from the link and for buffering packets to be transmitted upon the link. Computer system 300 may employ any suitable flow control mechanism for transmitting packets. For example, in one embodiment, each interface logic 318 stores a count of the number of each type of buffer within the receiver at the other end of the link to which that interface logic is connected. The interface logic does not transmit a packet unless the receiving interface logic has a free buffer to store the packet. As a receiving buffer is freed by routing a packet onward, the receiving interface logic transmits a message to the sending interface logic to indicate that the buffer has been freed. Such a mechanism may be referred to as a “coupon-based” system.

I/O devices 320A-320B may be any suitable I/O devices. For example, I/O devices 320A-320B may include devices for communicating with another computer system to which the devices may be coupled (e.g. network interface cards or modems). Furthermore, I/O devices 320A-320B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. Furthermore, any I/O device implemented as a card may also be implemented as circuitry on the main circuit board of the system 300 and/or software executed on a processing node. It is noted that the term “I/O device” and the term “peripheral device” are intended to be synonymous herein.

Although the discussion of the above embodiments has made reference to data being present in the cache lines loaded into the various embodiments of a cache, it should be noted that the term “data” is not intended to be limited. Accordingly, any given one of the caches discussed above may be a data cache or may be an instruction cache. Similarly, the cache lines may include data or instructions. Furthermore, caches in accordance with this disclosure may also be unified caches arranged to store both data and instructions.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A processor comprising:
an execution core;
a cache memory; and
a prefetcher coupled to the cache memory, wherein the prefetcher is configured to fetch a first cache line from a lower level memory and further configured to load the cache line into the cache, wherein, upon insertion into the cache, the first cache line is not designated as a most recently used (MRU) cache line;
wherein the cache is configured to designate the cache line as the MRU cache line responsive to the execution core asserting N demand requests for the cache line, wherein N is an integer greater than 1.

2. The processor as recited in claim 1, wherein the cache memory is configured to initially designate the first cache line as a least recently used (LRU) cache line, and is further configured to maintain the designation as the LRU cache line for the first cache line if the execution core has not asserted N demand requests for the first cache line.

3. The processor as recited in claim 2, wherein the cache is further configured to evict the first cache line from the cache, if the first cache line is designated as the LRU cache line, responsive to the prefetcher loading a second cache line, and wherein the cache is configured to designate the second cache line as the LRU cache line responsive to the prefetcher loading the second cache line.

4. The processor as recited in claim 2, wherein the processor includes a memory controller, wherein the cache is configured to evict the first cache line from the cache, if the first cache line is designated as the LRU cache line, responsive to the memory controller loading a second cache line, wherein the cache is configured to designate the second cache line as the MRU responsive to the memory controller loading the second cache line.

5. The processor as recited in claim 2, wherein the cache includes a plurality of counters each associated with a corresponding one of a plurality of cache lines, wherein a count value of each of the counters is changed responsive to a demand request for its corresponding cache line.

6. The processor as recited in claim 7, wherein a one of the plurality of counters associated with a cache line that is initially loaded into the cache as the LRU cache line is configured to be initialized to a value of N−1, and wherein the counter associated with the cache line initially loaded as the LRU is configured to decrement responsive to a demand request on that cache line.

7. The processor as recited in claim 8, wherein the cache is configured to designate as the MRU cache line the cache line initially loaded as the LRU responsive to a demand request when the corresponding counter has a value of 0.

8. The processor as recited in claim 2, wherein the cache is configured to maintain a priority list for plurality of cache lines stored therein, wherein the priority list is configured to indicated a priority for each of the plurality of cache lines, in descending order, from the cache line designated as the MRU to the cache line designated as the LRU.

9. The processor as recited in claim 1, wherein the first cache line is associated with a prefetch field, wherein the prefetcher is configured to set a bit in the prefetch field to indicate that the first cache line is a prefetched cache line.

10. The processor as recited in claim 1, wherein the first cache line is associated with a streaming field, wherein the prefetcher is configured to set a bit in the streaming field to indicate that the first cache line comprises streaming data.

11. A method comprising
a prefetcher prefetching a first cache line from a lower level memory;
loading the first cache line into the cache, wherein, upon insertion into the cache, the first cache line is not designated as a most recently used (MRU) cache line;
designating the first cache line as the MRU cache line responsive to N demand requests for the cache line, wherein N is an integer value greater than one; and
inhibiting the first cache line from being designated as the MRU cache line if the first cache line receives fewer than N demand requests.

12. The method as recited in claim 11, further comprising:
designating the first cache line as a least recently used (LRU) cache line upon insertion into the cache; and
inhibiting the first cache line from being promoted from the LRU position if the first cache line receives fewer than N demand requests.

13. The method as recited in claim 12 further comprising evicting the first cache line from the cache responsive to the prefetcher loading a second cache line into the cache prior to the first cache line receiving N demand requests, and designating the second cache line as the LRU cache line.

14. The method as recited in claim 12 further comprising a memory controller loading a second cache line into the cache;
designating the cache line as the MRU cache line; and
evicting the first cache line responsive to the memory controller loading the second cache line into the cache if the first cache line is designated as the LRU cache line.

15. The method as recited in claim 12 further comprising:
maintaining a priority list for a plurality of cache lines stored in the cache, wherein a priority level for each of the cache lines is listed in descending order from the MRU to the LRU; and
updating the list responsive to loading the cache with a new cache line.

16. The method as recited in claim 11, further comprising decrementing a promotion counter responsive to a first demand request for the first cache line.

17. The method as recited in claim 16, further comprising designating the first cache line as the MRU cache line responsive to a demand request when the promotion counter indicates a value of 0.

18. The method as recited in claim 11 further comprising the prefetcher indicating that the first cache line is a prefetched cache line.

19. The method as recited in claim 11, further comprising the prefetcher indicating that the first cache line includes streaming data.

20. The method as recited in claim 11 further comprising incrementing a confidence counter responsive to a demand request for the first cache line subsequent to storing the first cache line in the cache; and
decrementing the confidence counter responsive to the first cache line being evicted from the cache without receiving any demand requests.

21. A processor comprising:
an execution core;
a first cache configured to store a first plurality of cache lines; and
a first prefetcher coupled to the first cache, wherein the first prefetcher is configured to load a first cache line into the first cache;
wherein the first cache is configured to designate the first cache line loaded by the first prefetcher to be the least recently used (LRU) cache line of the first cache, and wherein the first cache is configured to designate the first cache line to a most recently used (MRU) position of the first cache only if the execution core requests the first cache line at least N times, wherein N is an integer value greater than 1.

22. The processor as recited in claim 21, wherein the first cache is a level one (L1) cache, and wherein the processor further comprises:
a second cache configured to store a second plurality of cache lines, wherein the second cache is a level two (L2) cache; and
a second prefetcher coupled to the second cache, wherein the second prefetcher is configured to load a second cache line into the second cache;
wherein the second cache is configured to designate the second cache line loaded by the second prefetcher to be the least recently used (LRU) cache line of the second cache, and wherein the second cache is configured to designate the second cache line to a most recently used (MRU) position of the second cache only if the execution core requests the second cache line at least M times.
